(19) United States
(12) Patent Application Publication
(10) Pub. No.: US 2020/0400511 A1
(43) Pub. Date: Dec. 24, 2020

(54) DETECTION DEVICE, TEMPERATURE DISTRIBUTION MEASUREMENT APPARATUS, AND METHOD OF MANUFACTURING DETECTION DEVICE

(71) Applicant: FUJITSU LIMITED, Kawasaki-shi (JP)

(72) Inventors: Kazushi Uno, Atsugi (JP); Takeo Kasajima, Machida (JP); Takahiro Arioka, Isehara (JP)

(73) Assignee: FUJITSU LIMITED, Kawasaki-shi (JP)

(21) Appl. No.: 17/012,106

(22) Filed: Sep. 4, 2020

Related U.S. Application Data
(63) Continuation of application No. PCT/JP2018/009899, filed on Mar. 14, 2018.

(51) Int. Cl. G01K 11/32; F28F 27/00; G01K 1/02; G01K 1/14

(52) U.S. Cl. CPC G01K 11/3206; F28F 27/00; G01K 2011/324; G01K 1/143; G01K 2011/322; G01K 1/026

(57) ABSTRACT

A detection device includes: an optical fiber including: a first part, when a plurality of panels each having a first section in which a plurality of superheater tubes with steam flowing inside the superheater tubes linearly extends in parallel to form a row and a second section in which the superheater tubes bend to separate from the first section in two sets and are radially connected to a side surface of a header is provided in an extending direction of the header and a direction in which the superheater tubes form a row in each panel is orthogonal to the extending direction of the header, laid along the superheater tubes in the first section of one panel from among the panels; a second part extending toward another panel adjacent to the one panel; and a third part laid along the superheater tubes in the first section of the other panel.

### CROSS-REFERENCE TO RELATED APPLICATION

This application is a continuation application of International Application PCT/JP2018/009899 filed on Mar. 14, 2018 and designated the U.S., the entire contents of which are incorporated herein by reference.

### FIELD

The present embodiment relates to a detection device, a temperature distribution measurement apparatus, and a method of manufacturing a detection device.

### BACKGROUND

A power generation boiler has multiple superheater tubes superheated by a furnace. A technique for measuring a temperature of the superheater tubes has been required. In view of the above, a technique of using an optical fiber to measure a temperature of each superheater tube has been disclosed.

Related art is disclosed in International Publication Pamphlet No. WO 2016/027763.

### SUMMARY

According to an aspect of the embodiments, a detection device includes: an optical fiber including: a first part, in a case where a plurality of panels each having a first section in which a plurality of superheater tubes with steam flowing inside the superheater tubes linearly extends in parallel to form a row and a second section in which the superheater tubes bend to separate from the first section in two sets and are radially connected to a side surface of a header is provided in an extending direction of the header and a direction in which the superheater tubes form a row in each panel is orthogonal to the extending direction of the header, laid along the superheater tubes in the first section of one panel from among the panels; a second part extending toward another panel adjacent to the one panel; and a third part laid along the superheater tubes in the first section of the other panel, wherein the first part and the third part are located between the superheater tubes along which the respective parts are laid, or the first part is located on an opposite side of the other panel on the superheater tubes along which the first part is laid and the third part is located on an opposite side of the one panel on the superheater tubes along which the third part is laid.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a schematic diagram of the general arrangement of a temperature distribution measurement apparatus according to an embodiment; and FIG. 1B is a block diagram for describing a hardware configuration of a control unit.

FIG. 2A is a schematic view of the general arrangement of a detection device; and FIG. 2B is a cross-sectional view taken along line A-A of FIG. 2A.

FIG. 3 is a graph illustrating components of backward scattered light.

FIG. 4A is a graph exemplarily illustrating the relationship between elapsed time after light pulse emission by a laser and the respective light intensities of a Stokes component and an anti-Stokes component; and FIG. 4B illustrates temperature calculated with a detection result of FIG. 4A and a formula (1).

FIG. 5 illustrates exemplary response when an optical fiber is partially immersed in hot water at about 55° C. at a room temperature of about 24° C.

FIG. 6 is a graph exemplarily illustrating a result obtained from FIG. 5 and a formula (2).

FIG. 7 is a schematic cross-sectional view of a power generation boiler.

FIG. 8 is an enlarged view of a superheater tube in a penthouse.

FIGS. 9A and 9B are views exemplarily illustrating laying of the detection device.

FIG. 10 is a view exemplarily illustrating an aggregation section and an expansion section.

FIG. 11 is a schematic perspective view exemplarily illustrating a connection mode of the superheater tube to be connected to an outlet header.

FIG. 12 is a diagram exemplarily illustrating a laying mode (comparative mode) of the detection device on the superheater tube at the same position of each panel.

FIG. 13 is a diagram exemplarily illustrating a laying structure of the detection device according to the embodiment.

FIG. 14A is a perspective view of the laying structure of the detection device; and FIG. 14B is a view of the detection device viewed from a panel direction.

FIGS. 15A and 15B are diagrams exemplarily illustrating a case where the detection device is alternately laid on the front side and the back side in the panel direction.

FIGS. 16A and 16B are diagrams exemplarily illustrating a case where the detection device is circumscribed in a bending direction at a bend of the superheater tube.

FIG. 17 is a diagram for describing exemplary laying of the detection device on the superheater tube.

FIG. 18 is a graph exemplarily illustrating measured temperature.

FIG. 19A is a diagram exemplarily illustrating a case where the detection device is laid to be circumscribed in the bending direction of the superheater tube at the bend of the superheater tube; and FIG. 19B is a diagram exemplarily illustrating a case where the detection device is laid to be inscribed in the bending direction of the superheater tube at the bend of the superheater tube.

FIG. 20A is a graph exemplarily illustrating a temperature measurement result of the example of FIG. 19A; and FIG. 20B is a graph exemplarily illustrating a temperature measurement result of the example of FIG. 19B.

FIG. 21 is a graph exemplarily illustrating a result of a heating experiment at about 700° C.

FIG. 22A is a diagram exemplarily illustrating a connection configuration with an adjacent row; and FIG. 22B is a diagram exemplarily illustrating a structure to be bound to a structural body.

FIG. 23 is a diagram exemplarily illustrating a flowchart representing a method of manufacturing the detection device.

### DESCRIPTION OF EMBODIMENTS

However, an optical fiber may break when the bend radius decreases. Furthermore, failure in obtaining adhesion to a superheater tube due to its own weight may result in poor temperature measurement accuracy. Those problems have not been considered in the technique described above.

For example, a detection device, a temperature distribution measurement apparatus, and a method of manufacturing a detection device capable of obtaining high temperature measurement accuracy while suppressing breakage of an optical fiber may be provided.

Hereinafter, an embodiment will be described with reference to the drawings.

### Embodiment

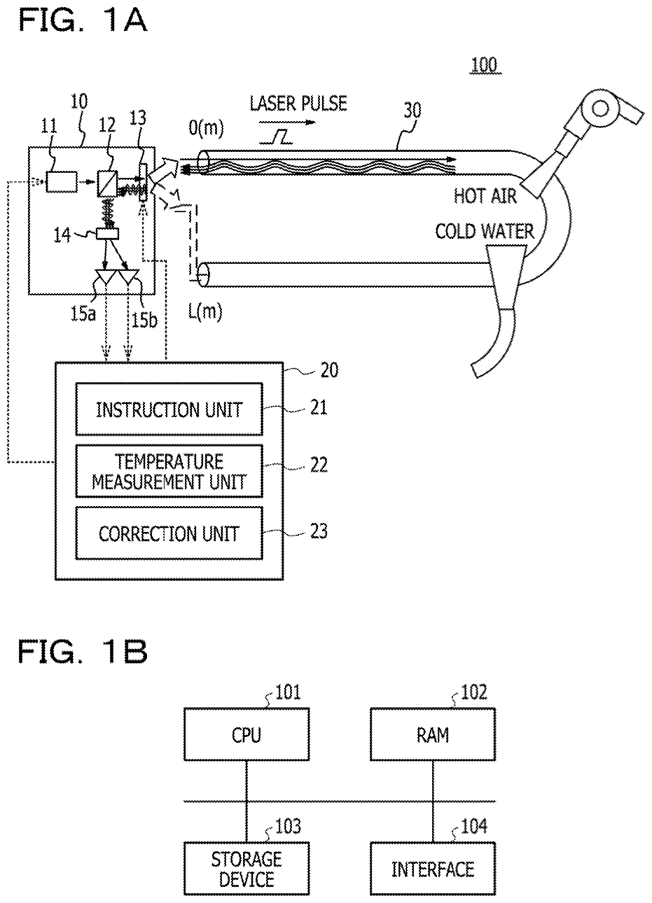

FIG. 1A is a schematic diagram of the general arrangement of a temperature distribution measurement apparatus 100. As exemplarily illustrated in FIG. 1A, the temperature distribution measurement apparatus 100 includes, for example, a measurement device 10, a control unit 20, and a detection device 30. The measurement device 10 includes, for example, a laser 11, a beam splitter 12, an optical switch 13, a filter 14, and a plurality of detectors 15a and 15b. The control unit 20 includes, for example, an instruction unit 21, a temperature measurement unit 22, and a correction unit 23.

FIG. 1B is a block diagram for describing a hardware configuration of the control unit 20. As exemplarily illustrated in FIG. 1B, the control unit 20 includes, for example, a CPU 101, a RAM 102, a storage device 103, and an interface 104. Each of those devices is connected via, for example, a bus. The central processing unit (CPU) 101 serves as a central processing unit. The CPU 101 includes one or more cores. The random access memory (RAM) 102 serves as a volatile memory that temporarily stores a program to be executed by the CPU 101, data to be processed by the CPU 101, and the like. The storage device 103 serves as a non-volatile storage device. Examples of the storage device 103 that can be used include a read only memory (ROM), a solid state drive (SSD) such as a flash memory, and a hard disk driven by a hard disk drive. Execution, by the CPU 101, of a temperature measurement program stored in the storage device 103 allows the control unit 20 to function as the instruction unit 21, the temperature measurement unit 22, and the correction unit 23. Note that the instruction unit 21, the temperature measurement unit 22, and the correction unit 23 may be hardware such as a dedicated circuit.

The laser 11 serves as a light source such as a semiconductor laser, and emits laser beams in a predetermined wavelength range following an instruction of the instruction unit 21. In the present embodiment, the laser 11 emits light pulses (laser pulses) at predetermined time intervals. The light pulses emitted from the laser 11 pass through the beam splitter 12 and enter the optical switch 13. The optical switch 13 serves as a switch that switches an emission destination (channel) of the light pulses having entered. In a double-end scheme, the optical switch 13 causes the light pulses to alternately enter a first end and a second end of the detection device 30 at constant cycles according to an instruction of the instruction unit 21. In a single-end scheme, the optical switch 13 causes the light pulses to enter either the first end or the second end of the detection device 30 according to an instruction of the instruction unit 21. The detection device 30 includes an optical fiber and is disposed along a predetermined path to be measured in temperature.

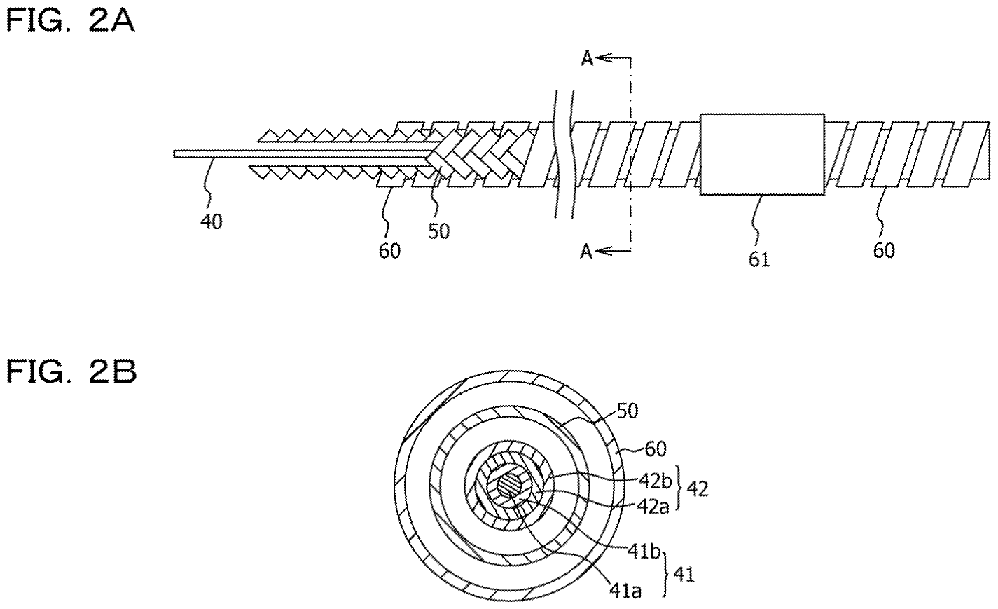

FIG. 2A is a schematic view of the general arrangement of the detection device 30. FIG. 2B is a cross-sectional view taken along line A-A of FIG. 2A, which is a cross-sectional view of the detection device 30. As exemplarily illustrated in FIGS. 2A and 2B, the detection device 30 includes, for example, an optical fiber 40, a ceramic braid 50, a metal tube 60, and a joint 61. Note that FIG. 2A partially illustrates the ceramic braid 50 inside the metal tube 60 and the optical fiber 40 inside the ceramic braid 50.

The optical fiber 40 has a structure in which a coating material 42 concentrically covers a linear optical fiber glass 41. The optical fiber glass 41 is a glass structure in which a cladding 41b concentrically covers a core 41a. The coating material 42 is not particularly limited, and includes, for example, carbon, or organic matter. In the present embodiment, the coating material 42 includes, for example, a carbon layer 42a that concentrically covers the optical fiber glass 41, and a polyimide layer 42b that concentrically covers the carbon layer 42a. The thickness of the carbon layer 42a is, for example, 100 nm or less. The thickness of the polyimide layer 42b is, for example, 30 μm or less. The coating material 42 has flexibility and elasticity higher than those of the optical fiber glass 41, whereby the bending resistance of the optical fiber 40 is improved with the coating material 42 covering the optical fiber glass 41. As a result, breakage of the optical fiber 40 can be suppressed.

The ceramic braid 50 has a structure that covers the optical fiber 40 in the circumferential direction. The ceramic braid 50 is a braid of heat-resistant ceramic fibers. Examples of the ceramic fiber that can be used include a glass fiber (high silicate glass fiber) containing SiO₂ component of 60 mass % or more, an alumina fiber, and the like. Furthermore, the ceramic fiber may be a composite material in which an organic material is added to the ceramic material described above such as the glass fiber and the alumina fiber.

The metal tube 60 has a structure that covers the ceramic braid 50 in the circumferential direction. The metal tube 60 is, for example, a flexible tube having flexibility. For example, the metal tube 60 is a metal spiral tube, a metal braid, or the like. Since the metal tube 60 is not necessarily dense, it may permeable to air, liquid, and the like. The metal tube 60 may have a structure in which multiple metal tubes are connected in the length direction by the joint 61.

The light pulses having entered the detection device 30 propagate through the optical fiber 40 in the detection device 30. The light pulses are gradually attenuated and propagate in the optical fiber 40 while generating forward scattered light traveling in the propagation direction of the light pulses and backward scattered light (return light) traveling in the feedback direction of the light pulses. The backward scattered light passes through the optical switch 13 and re-enters the beam splitter 12. The backward scattered light having entered the beam splitter 12 is emitted to the filter 14. The filter 14 serves as a wavelength division multiplexing (WDM) coupler or the like, and extracts the backward scattered light into a long-wavelength component (Stokes component to be described later) and a short-wavelength component (anti-Stokes component to be described later). The detectors 15a and 15b serve as photoreceptors. The detector 15a converts the received light intensity of the short-wavelength component in the backward scattered light into electric signals and transmits the electric signals to the temperature measurement unit 22. The detector 15b converts the received light intensity of the long-wavelength component in the backward scattered light into electric signals and transmits the electric signals to the temperature measurement unit 22. The temperature measurement unit 22 uses the Stokes component and the anti-Stokes component to measure temperature distribution in the extension direction of the detection device 30. The correction unit 23 corrects the temperature distribution measured by the temperature measurement unit 22.

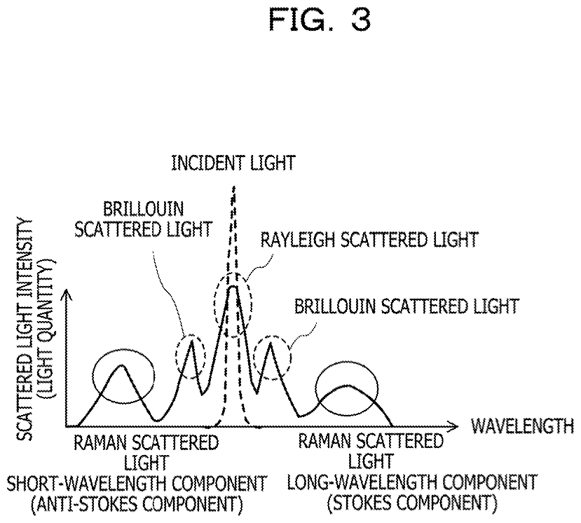

FIG. 3 is a graph illustrating components of the backward scattered light. As exemplarily illustrated in FIG. 3, the backward scattered light is broadly classified into three types. Those three types of light are, in descending order of light intensity and in the order closer to the incident light wavelength, Rayleigh scattered light to be used for an optical time domain reflectometer (OTDR) (optical pulse tester) or the like, Brillouin scattered light to be used in strain measurement or the like, and Raman scattered light to be used in temperature measurement or the like. The Raman scattered light is generated due to the interference between light and lattice vibration in the optical fiber 40 that varies in accordance with temperature. The constructive interference generates the short-wavelength component called the anti-Stokes component, and the destructive interference generates the long-wavelength component called the Stokes component.

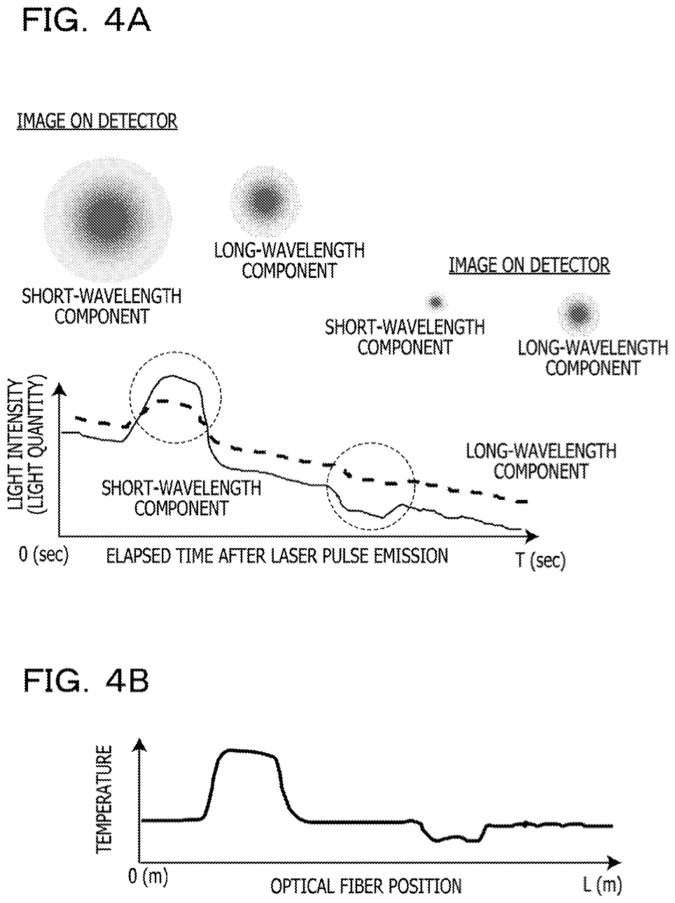

FIG. 4A is a graph exemplarily illustrating the relationship between elapsed time after light pulse emission by the laser 11 and the respective light intensities of the Stokes component (long-wavelength component) and the anti-Stokes component (short-wavelength component). The elapsed time corresponds to a propagation distance in the detection device 30 (location in the optical fiber 40). As exemplarily illustrated in FIG. 4A, the respective light intensities of the Stokes component and the anti-Stokes component both decrease with the elapsed time. This decrease results from the gradual attenuation and propagation of the light pulses in the optical fiber 40 while the light pulses generate the forward scattered light and the backward scattered light.

As exemplarily illustrated in FIG. 4A, the light intensity of the anti-Stokes component is higher than that of the Stokes component at a location where the temperature is high in the detection device 30, whereas it is lower than that of the Stokes component at a location where the temperature is low. Thus, detection of both components with the detectors 15a and 15b and use of the characteristic difference between both of the components enable detection of temperature at each location in the detection device 30. Note that, in FIG. 4A, the region indicating the maximum is a region where the detection device 30 is intentionally heated with a dryer or the like in FIG. 1A. Furthermore, the region indicating the minimum is a region where the detection device 30 is intentionally cooled with cold water or the like in FIG. 1A.

In the present embodiment, the temperature measurement unit 22 measures the temperature from the Stokes component and the anti-Stokes component every elapsed time. As a result, the temperature at each location in the detection device 30 can be measured. The temperature measurement unit 22 measures the temperature at each location in the detection device 30 by, for example, calculating the temperature according to the following formula (1). The light quantity corresponds to the light intensity. The use of the ratio of the two components highlights a weak component difference, whereby a practical value can be obtained. Note that a gain and offset depend on the specification of the optical fiber 40 of the detection device 30, whereby it is sufficient if they are calibrated in advance.

Temperature=gain/{offset−2×ln(anti-Stokes light quantity/Stokes light quantity)} (1)

FIG. 4B illustrates temperature calculated with the detection result of FIG. 4A and the formula (1) mentioned above. The horizontal axis in FIG. 4B represents a location in the detection device 30 calculated on the basis of the elapsed time. As exemplarily illustrated in FIG. 4B, detection of the Stokes component and the anti-Stokes component enables the temperature measurement at each location in the detection device 30. The laser 11 allows a light pulse to enter the detection device 30 at constant cycles, for example. The spatial resolution improves as the pulse width of the light pulse becomes narrower. On the other hand, the light quantity becomes smaller (=darker) as the pulse width becomes narrower so that the spire value of the pulse needs to be increased accordingly, whereby the gain in the formula mentioned above changes to a nonlinear response.

When the incident position from the optical switch 13 to the detection device 30 is fixed at the first end or the second end, the temperature can be measured using the formula (1) mentioned above. In a case where the incident position is switched between the first end and the second end at constant cycles as in the present embodiment, it is sufficient if the anti-Stokes light quantity and the Stokes light quantity are averaged (average value calculation) at each location of the detection device 30. This switching method is called, for example, a “loop type measurement”, “double-end measurement”, or “dual-end measurement”.

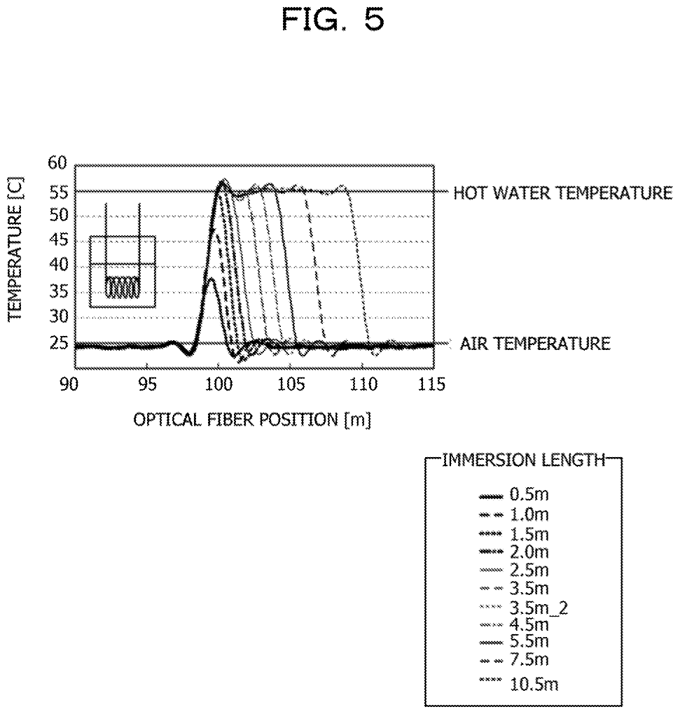

Next, the relationship between the measured temperature obtained from the Raman scattered light and the length of the section to be subject to the temperature measurement in the detection device 30 will be exemplified. FIG. 5 illustrates exemplary response when the optical fiber is partially immersed in hot water at about 55° C. at a room temperature of about 24° C. In a case where the immersion length increases from 0.5 m to 10.5 m, the peak temperature becomes 55° C., which is the same as the hot water, at about 2 m or more. Therefore, the section to be subject to the temperature measurement is preferably made longer to measure the temperature accurately.

Assuming that the temperature obtained by subtracting the accurate room temperature from the accurate hot water temperature is the temperature applied to the detection device 30, the sensitivity of the measurement system is defined by the following formula (2).

Sensitivity=(peak temperature at hot water immersion position −room temperature measured with optical fiber in the vicinity of immersion position)/applied temperature×100(%) (2)

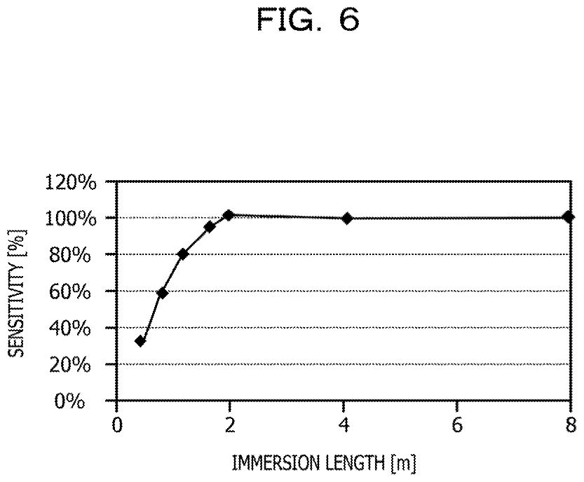

The result obtained from FIG. 5 and the formula (2) mentioned above is illustrated in FIG. 6. As exemplarily illustrated in FIG. 6, a slight overshoot is observed. This is because the impulse response of the system is not Gaussian, but a waveform with a higher-order peak and a negative component dose to the sinc function. The minimum length at which the sensitivity becomes or can be regarded as 100% is called minimum heating length.

From the results of FIGS. 5 and 6, it is understood that, when laid on two objects of the same length at the same temperature at different heating lengths (e.g., 1 m for one of them and 1.5 for the other one) shorter than the minimum heating length (e.g., 2 m), different temperatures are detected. Therefore, the following conditions are required for the length of the detection device 30 laid on the object to be measured in temperature.
Length equal to or longer than the minimum heating length
Substantially the same length in a case where it is difficult to lay the device at equal to or longer than the minimum heating length

Next, an object to be measured by the temperature distribution measurement apparatus 100 will be described. The temperature distribution measurement apparatus 100 measures a temperature of a superheater tube in which steam flows. The superheater tube is, for example, a superheater tube of a power generation boiler. Power generation boilers are mainly used in thermal power plants, and function to heat superheater tubes in a furnace, convert the steam flowing the inside thereof under high pressure into superheated steam, gather the steam in a header, and send the steam to a turbine.

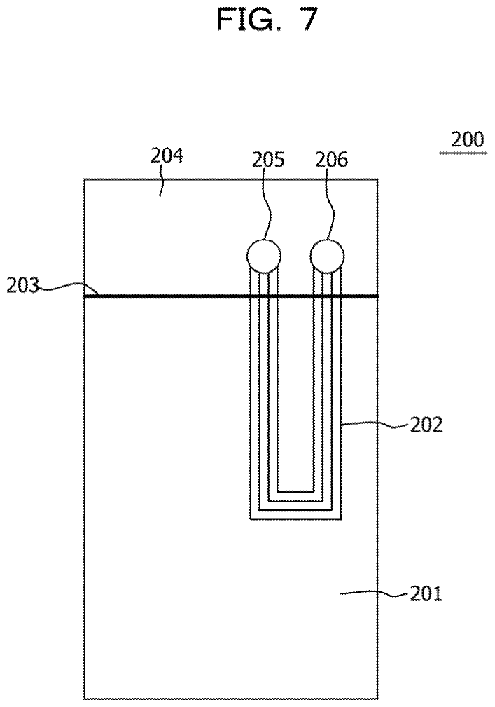

FIG. 7 is a schematic cross-sectional view of a power generation boiler 200. As exemplarily illustrated in FIG. 7, the power generation boiler 200 has a structure in which a plurality of superheater tubes 202 is disposed in a furnace 201. Steam is flowing in the superheater tube 202. One end of each of the superheater tubes 202 penetrates a ceiling 203 of the furnace 201 and is connected to an inlet header 205 in a penthouse 204. The other end of each of the superheater tubes 202 penetrates the ceiling 203 and is connected to an outlet header 206 in the penthouse 204.

The furnace 201 and the penthouse 204 are partitioned by the ceiling 203. Accordingly, the inlet header 205 and the outlet header 206 are prevented from being directly heated by fire and heat of the furnace 201. The penthouse 204 is a partitioned space above the ceiling 203. Steam is introduced into the superheater tube 202 from the inlet header 205, superheated by the furnace 201, and recovered by the outlet header 206.

Inside the furnace 201, the superheater tube 202 is heated by the fire and heat of the furnace 201. Inside the penthouse 204, the superheater tube 202 is not directly heated by fire while the heat of the furnace 201 is propagated thereto. Therefore, the superheater tube 202 in the penthouse 204 is suitable for the object to be measured in temperature. In view of the above, the object to be subject to temperature measurement by the temperature distribution measurement apparatus 100 is to be the superheater tube 202 in the penthouse 204. The inlet header 205 and the outlet header 206 are, for example, in a cylindrical shape with a bottom and a lid, and extend parallel to each other.

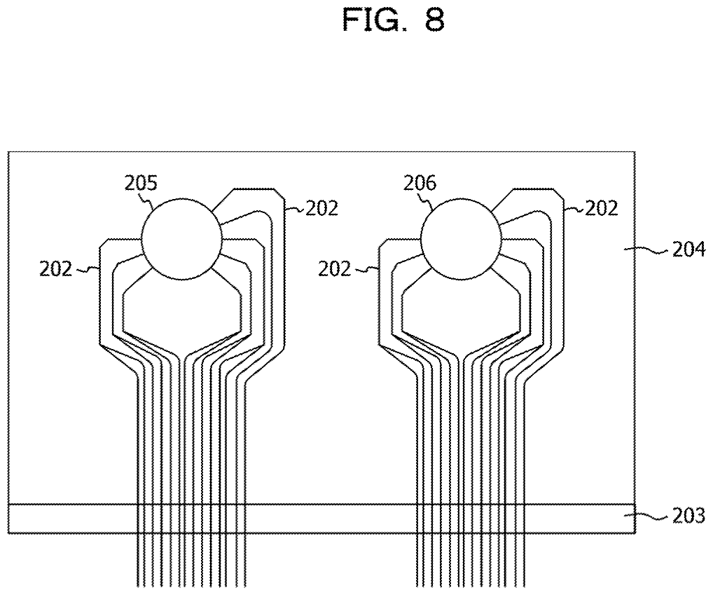

FIG. 8 is an enlarged view of the superheater tube 202 in the penthouse 204. In the example of FIG. 8, one end of each of the 14 superheater tubes 202 is connected to the inlet header 205, and the other end is connected to the outlet header 206, as an example. The respective superheater tubes 202 to be connected to the inlet header 205 in the penthouse 204 are arranged in rows to form the same plane in view of, for example, the occupied area, airtightness, and combustion efficiency, and are disposed close to and parallel to each other to vertically penetrate the ceiling 203. The respective superheater tubes 202 extend upward in two sets spaced apart from each other. Each of the superheater tubes 202 is radially connected to the side surface of the inlet header 205 so that every superheater tube 202 has substantially the same pressure loss. The radial shape in this case is a shape as viewed in the axial direction of the inlet header 205. Some of the superheater tubes 202 appear to branch midway. This is because they are shifted in the depth direction of the paper to overlap with each other.

The respective superheater tubes 202 to be connected to the outlet header 206 in the penthouse 204 are also arranged in rows to form the same plane in view of, for example, the occupied area, airtightness, and combustion efficiency, and are disposed close to and parallel to each other to vertically penetrate the ceiling 203. The respective superheater tubes 202 extend upward in two sets spaced apart from each other. Each of the superheater tubes 202 is radially connected to the side surface of the inlet header 205 so that every superheater tube 202 has substantially the same pressure loss. The radial shape in this case is a shape as viewed in the axial direction of the inlet header 205. Some of the superheater tubes 202 appear to branch midway. This is because they are shifted in the depth direction of the paper to overlap with each other.

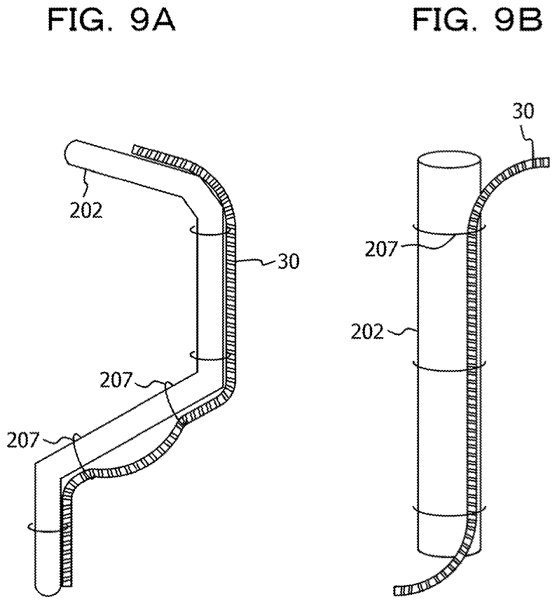

As described above, the length of the detection device 30 to be laid on the object to be measured in temperature is desirably a length equal to or longer than the minimum heating length. In view of the above, as exemplarily illustrated in FIG. 9A, it is conceivable to lay the detection device 30 along the superheater tube 202 including a bend section. In such a case, a sufficient length can be secured, whereby the length of the detection device 30 to be in contact with the superheater tube 202 becomes equal to or longer than the minimum heating length.

As described above, the detection device 30 has a structure in which the optical fiber 40 is covered (sheathed) with the metal tube 60. With such a detection device 30 being partially bound to the superheater tube 202 with a stainless steel wire 207 and brought into dose contact with the superheater tube 202, a temperature of the superheater tube 202 can be measured using radiation, heat transfer, and heat conduction. However, in a case where the superheater tube 202 bends, the metal tube 60 located relatively lower than the superheater tube 202 is weighed down under its own weight as the metal tube 60 is flexible. In such a case, the superheater tube 202 and the detection device 30 are spaced apart from each other so that the temperature of the superheater tube 202 and the temperature of the metal tube 60 are different from each other at the spaced portion, resulting in degradation in temperature measurement accuracy. Accordingly, the number of points bound with the stainless steel wire 207 increases to improve the temperature measurement accuracy. In such a case, time required to lay the detection device 30 significantly increases. In view of the above, it is not preferable to lay the detection device 30 in a place with a lot of bends.

In view of the above, as exemplarily illustrated in FIG. 98, the detection device 30 is laid along the superheater tube 202 linearly extending in the vertical direction in the present embodiment. In this case, even if the detection device 30 is fixed to the superheater tube 202 with a space, a separation is suppressed, and the detection device 30 and the superheater tube 202 can be brought into dose contact with each other. Accordingly, it becomes possible to improve the temperature measurement accuracy.

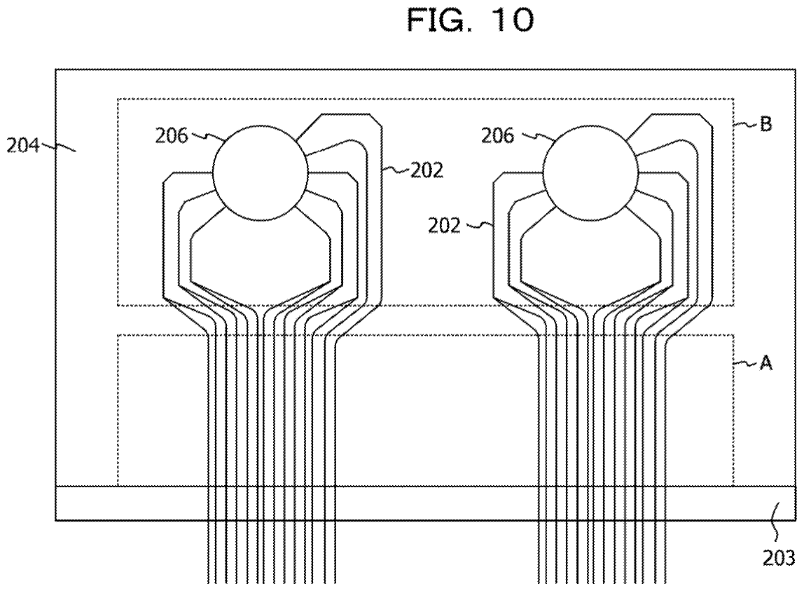

As exemplarily illustrated in FIG. 10, the superheater tubes 202 are linear in an aggregation section A, where multiple superheater tubes 202 are aggregated and penetrate the ceiling 203 to extend vertically upward, and in an expansion section B, where the superheater tubes 202 extend to separate from each other in two sets and then extend vertically upward.

In the expansion section B, the length of the straight section of the superheater tube 202 varies in size. For example, the outer superheater tube 202 is connected from above the outlet header 206 or the inlet header 205, whereby the straight section is longer. Therefore, the straight section of equal to or longer than the minimum heating length can be secured. However, the inner superheater tube 202 is connected below the outlet header 206 or the inlet header 205, whereby the straight section is shorter. Therefore, it is difficult to secure the straight section of equal to or longer than the minimum heating length. In view of the above, it is conceivable to fold the detection device 30 backward to lengthen the section to be in contact with the superheater tube 202. However, in the case of bending the optical fiber 40 with a radius smaller than an allowable bending radius (hereinafter referred to as minimum bending radius), the breakage probability of the optical fiber 40 increases. In an environment with a large temperature difference, the amount of expansion and contraction around the laid detection device 30 is also large, whereby the breakage probability further increases. That is, in an environment with a large temperature difference, a value of the minimum bending radius is large. The superheater tube 202 is normally operated with a variation of about ±20° C., and becomes an ambient temperature when, for example, the operation is planned to be stopped. That is, laying is desirably carried out with a bending radius larger than the specification value of the minimum bending radius at the ambient temperature. Accordingly, it is desirable that the detection device 30 is not folded back.

In view of the above, as illustrated in the aggregation section A of FIG. 10, the detection device 30 is laid mainly in the straight section of the superheater tube 202 in the present embodiment. In this case, the temperature measurement accuracy can be improved while breakage of the optical fiber 40 of the detection device 30 is suppressed.

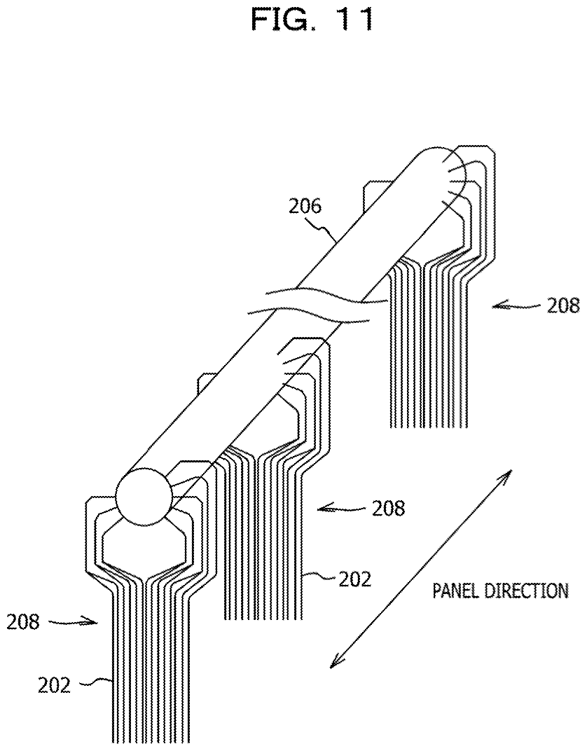

Next, a connection mode of the superheater tube 202 directed to the header will be described. FIG. 11 is a schematic perspective view exemplarily illustrating a connection mode of the superheater tube 202 to be connected to the outlet header 206. Note that the connection mode of the superheater tube 202 to be connected to the inlet header 205 is similar to the connection mode of the superheater tube 202 to be connected to the outlet header 206.

As described above, multiple superheater tubes 202 are arranged in rows to form the same plane, disposed dose to and parallel to each other, and connected to the outlet header 206. This set of the superheater tubes 202 will be referred to as a panel 208. Each panel 208 is disposed at a predetermined interval in the direction along which the outlet header 206 extends. The direction in which each panel 208 is arranged (direction in which the header extends) will also be referred to as a panel direction. The panel direction intersects the direction in which the superheater tubes 202 form a row in each panel, and is orthogonal in the example of FIG. 11.

In the present embodiment, the detection device 30 is laid along one of the superheater tubes 202 of the panel 208 at one end of the outlet header 206, and then the detection device 30 is laid along the superheater tube 202 at the same position of the adjacent panel 208. This laying is repeated so that the detection device 30 is laid up to the superheater tube 202 of the panel 208 at the other end of the outlet header 206.

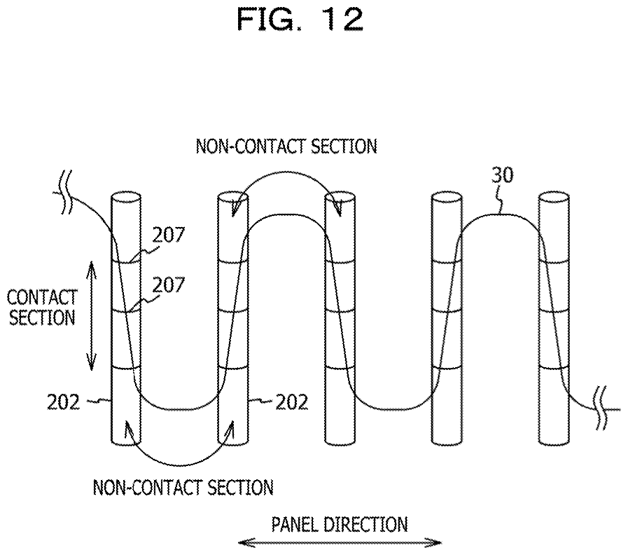

FIG. 12 is a diagram exemplarily illustrating a laying mode (comparative mode) of the detection device 30 on the superheater tube 202 at the same position of each panel. As exemplarily illustrated in FIG. 12, the detection device 30 is laid downward while being brought into contact with the superheater tube 202. A contact section with the superheater tube 202 is set to be 1 to 2 m. For example, the detection device 30 is fixed to the superheater tube 202 with a fixture such as the stainless steel wire 207. Next, the detection device 30 is extended toward the superheater tube 202 of the next adjacent panel. The detection device 30 does not contact the superheater tube 202 between the panels, and such a section will be referred to as a non-contact section. At the next panel, it is laid upward while being brought into contact with the superheater tube 202. Next, the detection device 30 is extended toward the superheater tube 202 of the next adjacent panel, and is laid downward while being brought into contact with the superheater tube 202. With the detection device 30 being laid in this manner, the bending radius can be increased without sharply bending the optical fiber. As a result, breakage of the optical fiber can be suppressed.

However, in the aggregation section A exemplarily illustrated in FIG. 10, a distance between two adjacent superheater tubes 202 is short, whereby the detection device 30 may be affected by a temperature of another superheater tube 202 not subject to the temperature measurement. In such a case, the temperature measurement accuracy may decrease. Furthermore, the detection device 30 and the superheater tube 202 may be spaced apart from each other at some portions due to the weight of the detection device 30. In such a case as well, the temperature measurement accuracy may decrease.

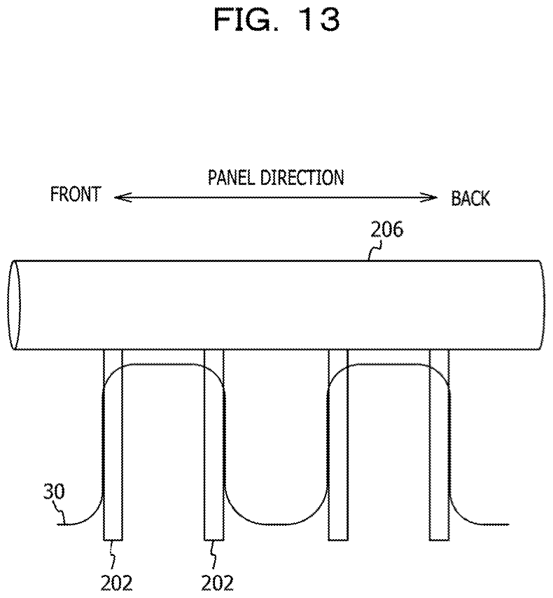

FIG. 13 is a diagram exemplarily illustrating a laying structure of the detection device 30 according to the present embodiment. As exemplarily illustrated in FIG. 13, in the present embodiment, the detection device 30 is laid to the superheater tube 202 of each panel alternately, such as one end side in the panel direction (hereinafter referred to as front side), the other end side in the panel direction (hereinafter referred to as back side), the front side in the panel direction, the back side in the panel direction, and so on. Therefore, the detection devices 30 laid on the respective superheater tubes 202 of two adjacent panels are both located on the panel side facing the superheater tube 202, or both located on the opposite side of the panel facing the superheater tube 202. In other words, among the respective parts of the detection device 30, a part in which laying is carried out along the superheater tube 202 in the aggregation section A of one of a plurality of panels will be referred to as a first part (contact section), a part of extending toward another panel adjacent to the one panel will be referred to as a second part (non-contact section), and a part in which laying is carried out along the superheater tube 202 in the aggregation section A at the other panel will be referred to as a third part (contact section). In this case, the first part and the third part are located between the superheater tubes 202 on which the respective parts are laid, or the first part is located on the opposite side of the other panel on the superheater tube 202 along which the first part is laid and the third part is located on the opposite side of the one panel on the superheater tube along which the third part is laid.

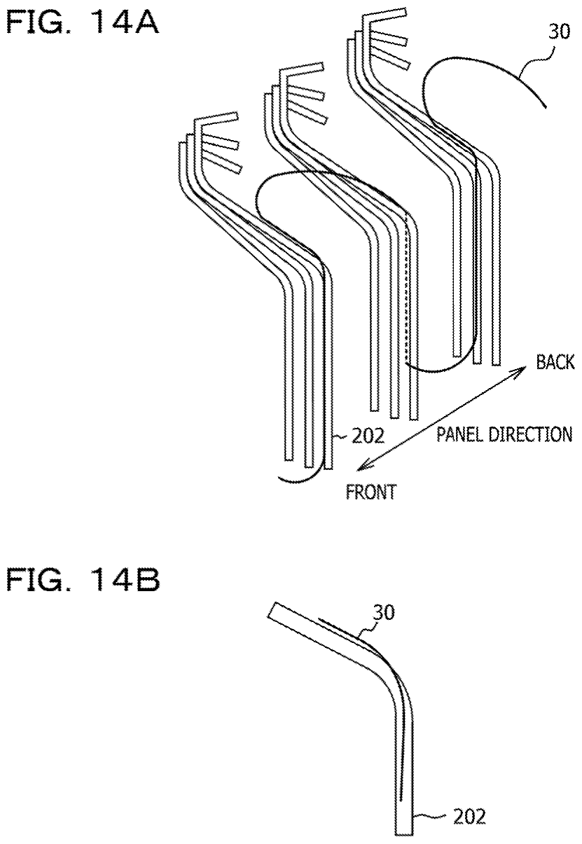

FIG. 14A is a perspective view of the laying structure of the detection device 30. FIG. 148 is a view of the detection device 30 viewed from the panel direction. As exemplarily illustrated in FIGS. 14A and 14, at the bend of the superheater tube 202, the detection device 30 is laid to be circumscribed in the bending direction of the superheater tube 202. In other words, the detection device 30 is laid outside (upper side) the superheater tube 202 when viewed from the center of curvature of the superheater tube 202 in the bending direction.

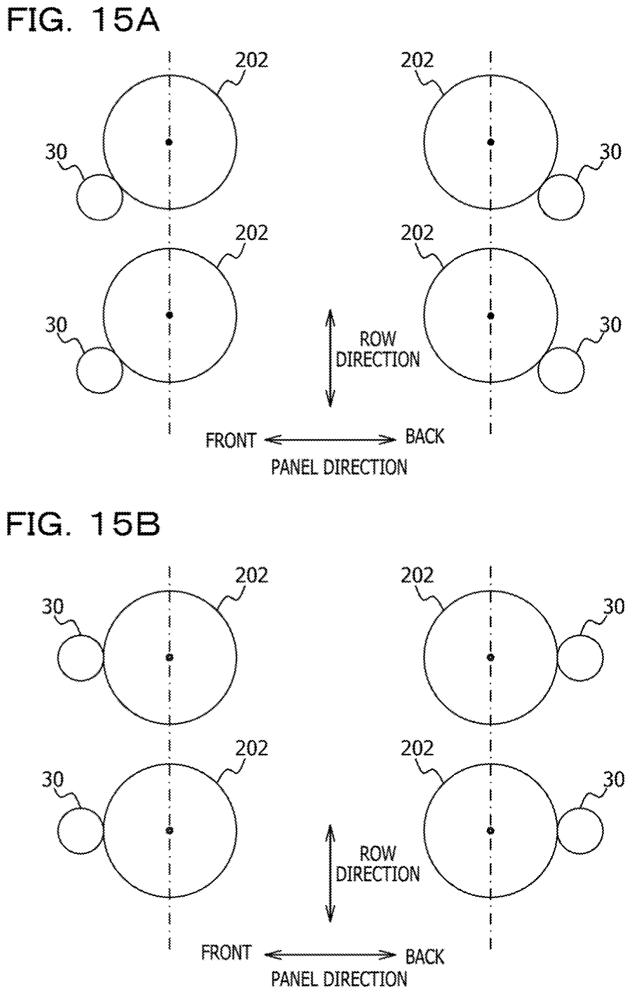

FIGS. 15A and 15B are diagrams exemplarily illustrating a case where the detection device 30 is alternately laid on the front side and the back side in the panel direction. In FIGS. 15A and 158, the detection device 30 is laid on the front side of the superheater tube 202 in the panel on the front side, and the detection device 30 is laid on the back side of the superheater tube 202 in the panel on the back side. As exemplarily illustrated in FIG. 15A, the front side of the superheater tube 202 indicates that the central axis of the detection device 30 is located on the front side of the line passing through the central axis of each superheater tube 202 in the panel. The back side of the superheater tube 202 indicates that the central axis of the detection device 30 is located on the back side of the line passing through the central axis of each superheater tube 202 in the panel. However, as exemplarily illustrated in FIG. 15B, the detection device 30 is preferably located at the apex of the superheater tube 202 in the panel direction to suppress the influence of the adjacent superheater tube 202.

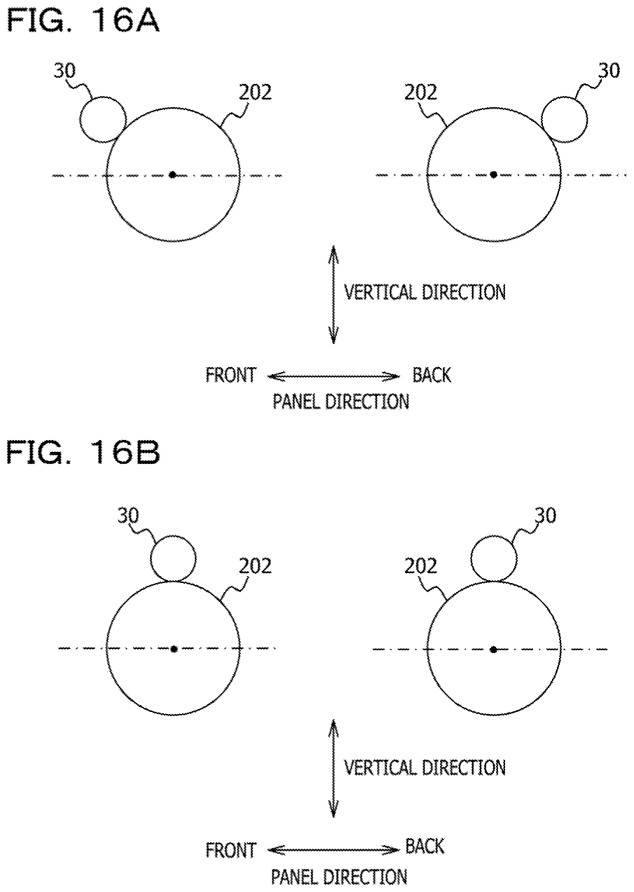

FIGS. 16A and 16B are diagrams exemplarily illustrating a case where the detection device 30 is circumscribed in the bending direction at the bend of the superheater tube 202. As exemplarily illustrated in FIG. 16A, in a case where the detection device 30 is disposed on the front side of the superheater tube 202, the central axis of the detection device 30 is located on the upper side of the line passing through the central axis of the superheater tube 202 on the front side of the bend of the detection device 30. Furthermore, in a case where the detection device 30 is disposed on the back side of the superheater tube 202, the central axis of the detection device 30 is located on the upper side of the line passing through the central axis of the superheater tube 202 on the back side of the bend of the detection device 30. However, as exemplarily illustrated in FIG. 168, the detection device 30 is preferably located at the upper apex of the superheater tube 202 from the viewpoint of suppressing the separation between the detection device 30 and the superheater tube 202 due to the weight of the detection device 30.

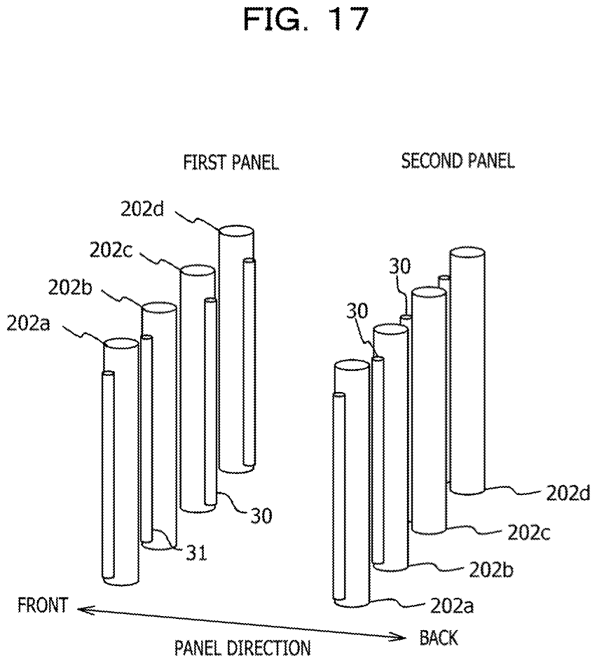

Next, an effect of the case where the detection device 30 is alternately laid on the front side and the back side in the panel direction will be described. FIG. 17 is a diagram for describing exemplary laying of the detection device 30 on the superheater tube 202. As exemplarily illustrated in FIG. 17, in the first panel, a first superheater tube 202a, a second superheater tube 202b, a third superheater tube 202c, and a fourth superheater tube 202d are supposed to be disposed in that order in a row while being close to each other.

At the second superheater tube 202b, the detection device 30 is laid along the second superheater tube 202b between the first superheater tube 202a and the second superheater tube 202b. At the third superheater tube 202c, the detection device 30 is laid along the third superheater tube 202c on the back side of the third superheater tube 202c.

In such a laying structure, temperature measurement was carried out on the basis of a simulation using a natural convection heat transfer model of a vertical plate. The diameter of each superheater tube was set to 50 mm. The diameter of the detection device 30 (diameter of exterior stainless steel tube) was set to 4.6 mm. A gap between respective superheater tubes in the same panel was set to 5 mm. The temperature of the first superheater tube 202a and the fourth superheater tube 202d was set to 650° C. The temperature of the second superheater tube 202b and the third superheater tube 202c was set to 550° C. In this case, a temperature dose to 550° C. is desirably measured at the second superheater tube 202b and the third superheater tube 202c.

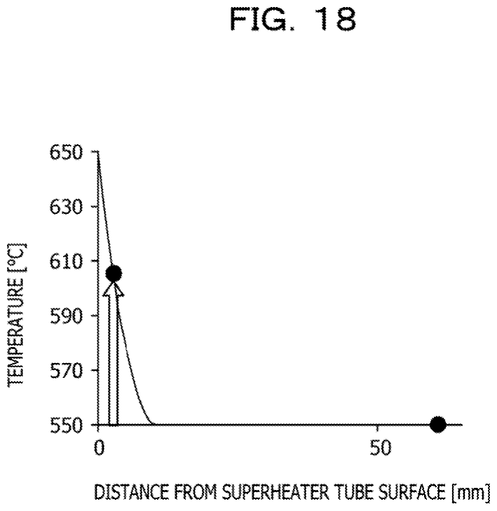

FIG. 18 is a graph exemplarily illustrating the measured temperature. In FIG. 18, the vertical axis represents measured temperature, and the horizontal axis represents a distance from the surface of the adjacent superheater tube. The plot on the left side indicates the temperature measured by the detection device 30 laid on the second superheater tube 202b. The plot on the right side indicates the temperature measured by the detection device 30 laid on the third superheater tube 202c. As exemplarily illustrated in FIG. 18, the temperature measured by the detection device 30 laid on the second superheater tube 202b was 606° C. This is considered to be affected by the temperature of the first superheater tube 202a adjacent to the second superheater tube 202b. On the other hand, the temperature measured by the detection device 30 laid on the third superheater tube 202c was 550° C. This is considered not to be affected by the temperature of the adjacent superheater tube as the detection device 30 was laid on the back side in the panel direction. As described above, with the detection device 30 being laid on the superheater tube 202 of each panel alternately on the front side and the back side in the panel direction, it becomes possible to suppress the influence of the temperature of the adjacent superheater tube. Accordingly, it becomes possible to improve the temperature measurement accuracy.

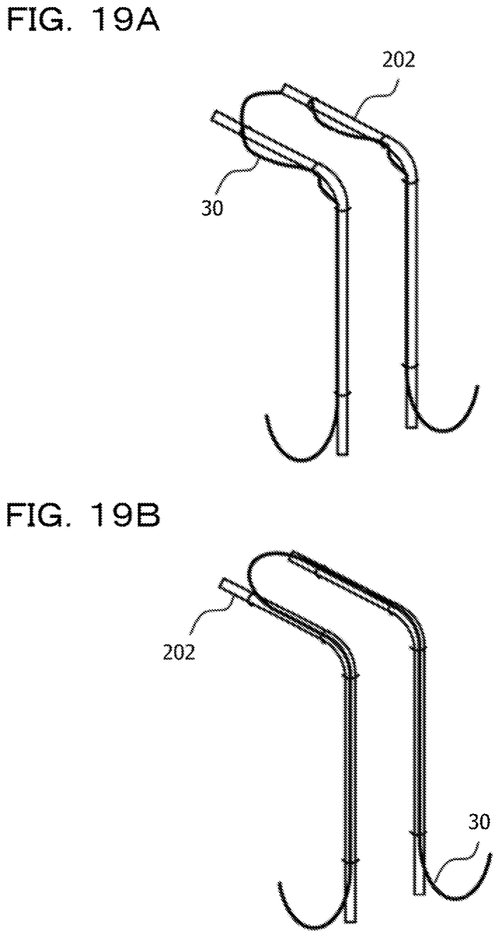

Next, the effect of a case where the detection device 30 is laid to be circumscribed in the bending direction of the superheater tube 202 at the bend of the superheater tube 202 will be described. FIG. 19A is a diagram exemplarily illustrating a case where the detection device 30 is laid to be inscribed in the bending direction of the superheater tube 202 at the bend of the superheater tube 202. On the other hand, FIG. 19B is a diagram exemplarily illustrating a case where the detection device 30 is laid to be circumscribed in the bending direction of the superheater tube 202 at the bend of the superheater tube 202.

In the example of FIG. 19A, the detection device 30 is brought into contact with the superheater tube 202 over 1 m in a section extending in the vertical direction. The detection device 30 is laid under the superheater tube 202 at the bend, whereby the detection device 30 sags due to its own weight. Accordingly, it is spaced apart from the superheater tube 202 by 10 cm. At the point where the detection device 30 is fixed to the superheater tube 202 with the fixture, the detection device 30 is brought into dose contact with the superheater tube 202 over 5 cm. Thereafter, the detection device 30 is spaced apart from the superheater tube 202 over 20 cm, and the detection device 30 is brought into dose contact with the superheater tube 202 over 5 cm at the fixed point. Thereafter, the non-contact section to the adjacent panel is set to 50 cm. In the example of FIG. 19A, the detection device 30 is brought into contact with the superheater tube 202 over 1 m in the section extending in the vertical direction. The detection device 30 is laid on the superheater tube 202 at the bend, thereby being in dose contact over 40 cm. Thereafter, the non-contact section to the adjacent panel is set to 50 cm.

In such a laying structure, temperature measurement was carried out on the basis of a response simulation using FIGS. 5 and 6. The diameter of each superheater tube was set to 50 mm. The diameter of the detection device 30 (diameter of exterior stainless steel tube) was set to 4.6 mm. A gap between respective superheater tubes in the same panel was set to 5 mm. The atmospheric temperature was set to 550° C. The temperature of the superheater tube 202 was set to 600° C. In this case, a temperature dose to 600° C. is desirably measured at each superheater tube 202.

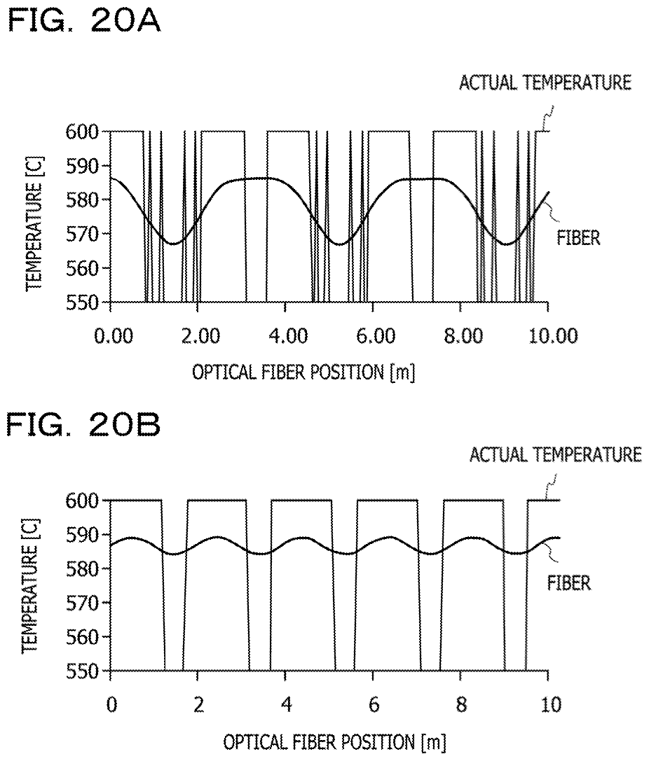

FIG. 20A is a graph exemplarily illustrating a temperature measurement result of the example of FIG. 19A. As exemplarily illustrated in FIG. 20A, while a temperature dose to 600° C. was detected as a temperature of each superheater tube 202, a temperature dose to 600° C. was also detected even in the non-contact section. This is considered that a resolution of the temperature measurement decreases due to the condition in which a part where the detection device 30 and the superheater tube 202 are in dose contact with each other and a part where they are spaced apart from each other are mixed.

On the other hand, FIG. 20B is a graph exemplarily illustrating a temperature measurement result of the example of FIG. 19B. As exemplarily illustrated in FIG. 208, a temperature dose to 600° C. was detected as a temperature of each superheater tube 202. Moreover, a temperature dose to the atmospheric temperature was detected in the non-contact section. This is considered that, as the detection device 30 and the superheater tube 202 can be in dose contact with each other at the part where the detection device 30 is laid along the superheater tube 202, a dose-contact part and a separate part of the detection device 30 and the superheater tube 202 are not mixed so that the resolution of the temperature measurement improves. As described above, with the detection device 30 being laid to be inscribed in the bending direction of the superheater tube 202 in the upper non-contact section, the dose-contact section and the separate section can be accurately managed. As a result, the temperature measurement accuracy improves, thereby enabling, for example, accurate leak detection and life estimation.

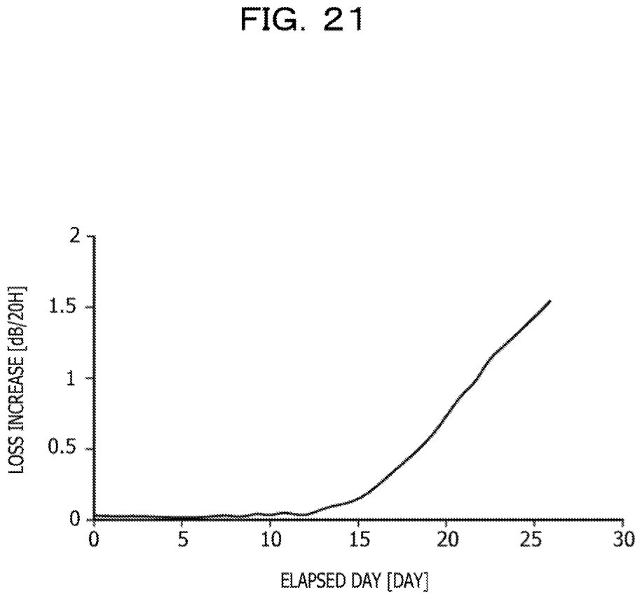

Meanwhile, it is known that a transmission loss of an optical fiber increases at a high temperature. FIG. 21 is a graph exemplarily illustrating a result of a heating experiment at about 700° C. A graded index (GI) multimode fiber to be used in the temperature distribution measurement apparatus 100 has a tendency that the transmission loss clearly increases as time passes. Meanwhile, in FIG. 1A, the transmission loss of the optical fiber allowed per loop is limited under the constraint that the spire value of the laser pulse is limited to the linear region that does not lead to stimulated Raman scattering. Therefore, the transmission loss per loop can be preferably adjusted and set relatively easily.

Furthermore, an accurate temperature cannot be obtained in the temperature distribution measurement apparatus 100 unless the transmission loss that increases successively is corrected. This is because the wavelengths of the Stokes component and the anti-Stokes component are generally different, whereby a difference in the magnitude of the transmission loss to occur arises and a difference corresponding to the difference occurs in a temperature to be calculated. In order to avoid this, it is necessary to have locations where no transmission loss occurs under known temperature conditions to sandwich a location where the transmission loss occurs, and it is preferable to have such a laying structure.

In the example of FIG. 5, for example, in a case where the heating length (immersion length in FIG. 5) is 5.5 m and a transmission loss occurs in the section of 5.5 m so that the temperatures near 100 m and 105 m are not constant while they should be constant originally, the temperatures can be corrected to the accurate temperature on the basis of the section from 90 m to 95 m and the section from 110 m to 115 m as long as those two end sections are the ambient temperature (e.g., 0° C. to 40° C.) and known.

Meanwhile, in the laying structure according to the present embodiment, the leading end of the detection device 30 once passes from the panel at the end to the panel at the opposite end to be along the longitudinal direction of the header. In the case of carrying out such work promptly, the pulling side and the feeding side preferably have one-to-one correspondence, and such a laying structure is preferable.

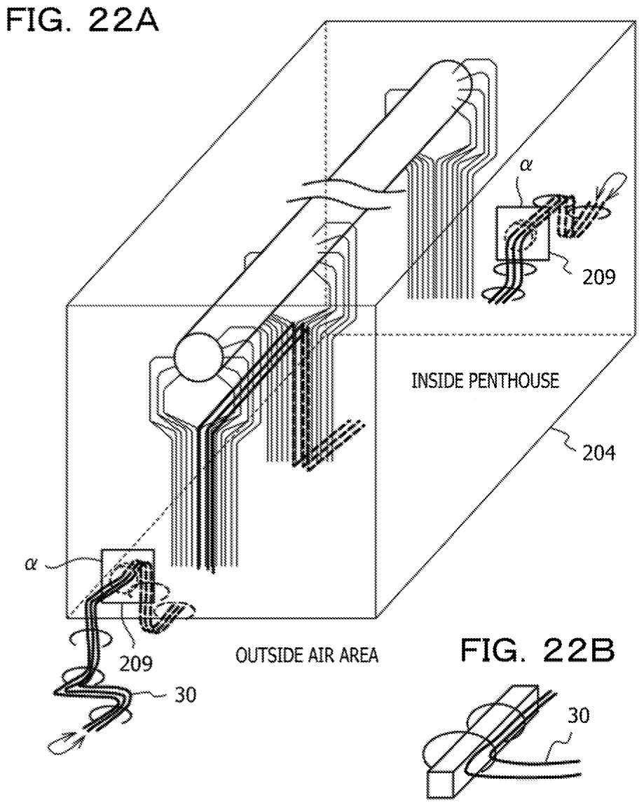

As a configuration that satisfies the requirements of those laying structures, FIG. 22A exemplarily illustrates a connection configuration with an adjacent row. As exemplarily illustrated in FIG. 22A, the detection device 30 is introduced into the penthouse 204 from an outlet a provided at a part of the wall of the penthouse 204, laid along the superheater tube 202 of each panel, and pulled out of the penthouse 204 from the outlet a. With respect to the detection device 30 in this case, the introduction part located outside the penthouse 204 through which the detection device 30 is introduced into the penthouse 204 and the drawing part through which the detection device 30 laid along the superheater tube 202 of each panel is drawn out of the penthouse 204 from the outlet a are bound together outside the penthouse 204.

In the binding section, predetermined lengths equal to or longer than the minimum heating length pass through paths that can be regarded as the same, and they can be considered to have the same temperature, whereby the temperature of the detection device 30 connected to the downstream side can be corrected sequentially with reference to the temperature of the detection device 30 connected to the (upstream) side closer to a measurement device not affected by the transmission loss. The correction unit 23 in FIG. 1A corrects the temperature measured by the temperature measurement unit 22 on the assumption that the temperatures in the binding section are the same temperature.

Note that, in the path from the end of the laying part on the superheater tube to the outlet, it is preferable to be bound at a plurality of points directly or indirectly via a similar structure, as exemplarily illustrated in FIG. 22B. In this configuration, the predetermined lengths equal to or longer than the minimum heating length pass through the paths that can be regarded as the same, and they can be considered to have the same temperature. By providing two standards of the outside temperature and the temperature inside the penthouse 204 (e.g., 400° C.), more suitable correction can be made possible. Furthermore, even in a case where the transmission loss increases more than expected, the measurement can be continued by increasing the number of loops without stopping the operation of a power plant or the like.

According to the present embodiment, in a case where a plurality of the panels 208 each having the aggregation section A (first section) in which a plurality of superheater tubes 202 with steam flowing inside the superheater tubes 202 linearly extends in parallel to form a row and the expansion section B (second section) in which the superheater tubes 202 bend to separate from the aggregation section A in two sets and are radially connected to the side surface of the header is provided at predetermined intervals in the extending direction of the header and the direction in which a plurality of the superheater tubes 202 forms a row in each panel is orthogonal to the extending direction of the header, the detection device 30 includes the first part laid along the superheater tubes in the aggregation section A of one panel from among the panels, the second part extending toward another panel adjacent to the one panel, and the third part laid along the superheater tube 202 in the aggregation section A of the other panel. In this case, the first part and the third part are located between the superheater tubes 202 on which the respective parts are laid, or the first part is located on the opposite side of the other panel on the superheater tube 202 along which the first part is laid and the third part is located on the opposite side of the one panel on the superheater tube along which the third part is laid. In this case, the detection device 30 is not required to be folded back, whereby breakage of the optical fiber 40 can be suppressed. Furthermore, the influence of the temperature of the adjacent superheater tube 202 is suppressed, whereby high temperature measurement accuracy can be obtained. By obtaining high temperature measurement accuracy, it becomes possible to estimate the presence or absence of breakage of the superheater tube 202 and to estimate a life.

In a case where the first part is located on the opposite side of the other panel on the superheater tube 202 along which the first part is laid and the third part is located on the opposite side of the one panel on the superheater tube 202 along which the third part is laid, in the bend section, laying is preferably carried out to be circumscribed when viewed from the center of curvature of the superheater tube 202 in the bending direction. With this configuration, it becomes possible to suppress the separation between the detection device 30 and the superheater tube 202 caused by the weight of the detection device 30. As a result, high temperature measurement accuracy can be obtained.

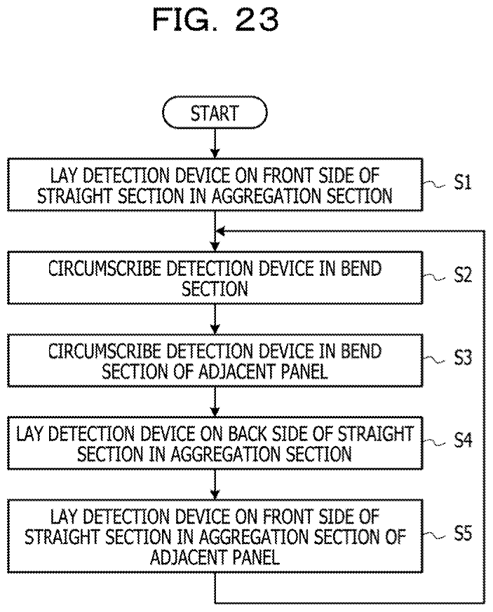

FIG. 23 is a diagram exemplarily illustrating a flowchart representing a method of manufacturing the detection device 30. As exemplarily illustrated in FIG. 23, in any of the panels, the detection device 30 is laid on the front side of the straight section of the superheater tube 202 in the aggregation section A (step S1). Next, in the bend section, the detection device 30 is laid to be circumscribed when viewed from the center of curvature of the superheater tube 202 in the bending direction (step S2). Next, an upper non-contact section is provided, and in the bend section of the same superheater tube 202 in the adjacent panel, the detection device 30 is laid to be circumscribed when viewed from the center of curvature of the superheater tube 202 in the bending direction (step S3). Next, the detection device 30 is laid on the back side of the straight section in the aggregation section A (step S4). Next, a lower non-contact section is provided, and the detection device 30 is laid on the front side of the straight section in the aggregation section A of the same superheater tube 202 in the adjacent panel (step S5). Thereafter, steps S2 to S5 are repeated, whereby the detection device 30 can be manufactured.

The embodiment of the present invention has been described in detail; however, the present invention is not limited to such a specific embodiment, and various modifications and alterations can be made within the scope of gist of the present invention described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A detection device comprising:
an optical fiber including: a first part, in a case where a plurality of panels each having a first section in which a plurality of superheater tubes with steam flowing inside the superheater tubes linearly extends in parallel to form a row and a second section in which the superheater tubes bend to separate from the first section in two sets and are radially connected to a side surface of a header is provided in an extending direction of the header and a direction in which the superheater tubes form a row in each panel is orthogonal to the extending direction of the header, laid along the superheater tubes in the first section of one panel from among the panels;
a second part extending toward another panel adjacent to the one panel; and
a third part laid along the superheater tubes in the first section of the other panel, wherein
the first part and the third part are located between the superheater tubes along which the respective parts are laid, or the first part is located on an opposite side of the other panel on the superheater tubes along which the first part is laid and the third part is located on an opposite side of the one panel on the superheater tubes along which the third part is laid.

2. The detection device according to claim 1, wherein
in a case where the first part is located on the opposite side of the other panel on the superheater tubes along which the first part is laid and the third part is located on the opposite side of the one panel on the superheater tubes along which the third part is laid, in a bend section of the second section, the detection device is laid to be circumscribed when viewed from a center of curvature of the superheater tubes in a bending direction.

3. The detection device according to claim 1, wherein
the optical fiber is inserted through a metal flexible tube having air permeability and liquid permeability.

4. The detection device according to claim 1, wherein
the header is disposed inside a partitioned space,
the detection device further comprising:
an introduction part located outside the space through which the detection device is introduced into the space; and
a drawing part through which the detection device laid along one of the superheater tubes is drawn out of the space, and
the introduction part and the drawing part are bound together outside the space.

5. A temperature distribution measurement apparatus comprising:
a detection device an optical fiber including:
a first part, in a case where a plurality of panels each having a first section in which a plurality of superheater tubes with steam flowing inside the superheater tubes linearly extends in parallel to form a row and a second section in which the superheater tubes bend to separate from the first section in two sets and are radially connected to a side surface of a header is provided in an extending direction of the header and a direction in which the superheater tubes form a row in each panel is orthogonal to the extending direction of the header, laid along the superheater tubes in the first section of one panel from among the panels;
a second part extending toward another panel adjacent to the one panel; and
a third part laid along the superheater tubes in the first section of the other panel,
wherein the first part and the third part are located between the superheater tubes along which the respective parts are laid, or the first part is located on an opposite side of the other panel on the superheater tubes along which the first part is laid and the third part is located on an opposite side of the one panel on the superheater tubes along which the third part is laid;
a light source that makes light incident on the optical fiber; and
a temperature measurement circuit that measures a temperature of each measurement point of the optical fiber on a basis of backward scattered light from the optical fiber.

6. A method of manufacturing a detection device comprising:
in a case where a plurality of panels each having a first section in which a plurality of superheater tubes with steam flowing inside the superheater tubes linearly extends in parallel to form a row and a second section in which the superheater tubes bend to separate from the first section in two sets and are radially connected to a side surface of a header is provided in an extending direction of the header and a direction in which the superheater tubes form a row in each panel is orthogonal to the extending direction of the header, laying a first part of an optical fiber along the superheater tubes in the first section of one panel from among the panels;
extending a second part of the optical fiber toward another panel adjacent to the one panel; and
laying a third part of the optical fiber along the superheater tubes in the first section of the other panel, wherein
the first part and the third part are located between the superheater tubes along which the respective parts are laid, or the first part is located on an opposite side of the other panel on the superheater tubes along which the first part is laid and the third part is located on an opposite side of the one panel on the superheater tubes along which the third part is laid.

7. The method of manufacturing a detection device according to claim 6, wherein
in a case where the first part is located on the opposite side of the other panel on the superheater tubes along which the first part is laid and the third part is located on the opposite side of the one panel on the superheater tubes along which the third part is laid, in a bend section of the second section of the superheater tubes along which each part is laid, the detection device is laid to be circumscribed when viewed from a center of curvature of the superheater tubes in a bending direction.
